(19) United States
(12) Patent Application Publication
(10) Pub. No.: US 2022/0172236 A1
(43) Pub. Date: Jun. 2, 2022

(54) VEHICLE ALLOCATION SYSTEM, AND VEHICLE CANDIDATE DISPLAY METHOD

(71) Applicant: Hitachi, Ltd., Tokyo (JP)

(72) Inventors: Manabu HASEGAWA, Tokyo (JP); Tadayoshi KOSAKA, Tokyo (JP); Naoki FURUYA, Tokyo (JP); Kazuya UYAMA, Tokyo (JP)

(73) Assignee: Hitachi, Ltd., Tokyo (JP)

(21) Appl. No.: 17/539,476

(22) Filed: Dec. 1, 2021

(30) Foreign Application Priority Data
Dec. 2, 2020 (JP) 2020-199962

(51) Int. Cl. G06Q 30/02; G06Q 10/06; G06Q 10/04; G06Q 10/08

(52) U.S. Cl. CPC G06Q 30/0205; G06Q 10/0833; G06Q 10/047; G06Q 10/06315

(57) ABSTRACT

A vehicle allocation system includes a processor, a recording unit, and a display apparatus. The recording unit includes a vehicle information recording unit which records information regarding delivery vehicles, a cargo information recording unit which records information regarding new delivery packages, and an index calculation processing unit which calculates a plurality of indexes and executes display of information based on the calculated indexes. The processor reads the index calculation processing unit to calculate for each delivery vehicle an index pertaining to movement distance, an index pertaining to profit, and an index pertaining to a ratio of loaded travel distance to total travel distance, uses weights on the calculated indexes to calculate an overall index for each delivery vehicle, and causes display of information regarding the indexes and information in which the overall indexes for the delivery vehicles are lined up in descending order.

### BACKGROUND OF THE INVENTION

### 1. Field of the Invention

The present invention relates to a vehicle allocation system and a vehicle candidate display method.

### 2. Description of the Related Art

In recent years, in the business of deliveries which is responsible for logistics, the necessity of joint delivery (in other words, delivery that mixes packages from a plurality of consignors) has been increasing due to insufficient turnout of drivers. Typically, in delivery business, a delivery business operator determines the route for each vehicle by the day before, and each vehicle carries out delivery in accordance with the determined route on the day. However, for example, in the case where a sudden order arrives from a consignor on the day, it is necessary to allocate delivery of a package based on this sudden order to one vehicle for which the route has already been determined. In order to resolve this problem, for example, a person performing allocation based on feelings can be considered, but, in this case, the problem that variation arises and scaling of the system will be difficult can be considered. Meanwhile, Japanese Patent Laid-open No. 2019-211875 discloses a technique of calculating for each vehicle a value from time and/or distance required for the vehicle to move from a place of arrival to a desired place, and determining a vehicle to prioritize in accordance with the calculated values.

### SUMMARY OF THE INVENTION

With a work mode for each delivery business operator in which delivery planning and delivery are performed by the same company, optimization in relation to delivery by one company is individually performed on the basis of the viewpoint of that one company (in other words, even if a sudden order arrives, the sudden order is dealt with by performing allocation on the basis of the viewpoint of that one company). However, with a work mode in which delivery planning and delivery are performed among a plurality of companies such as company A which is a platform provider that performs delivery planning, company B and company C which are delivery business operators that perform delivery, and so on, overall optimization (in other words, optimization that includes other companies) is necessary, but it is considered that overall optimization has not been studied.

Here, in order to perform the abovementioned overall optimization, for example, a method in which a platform provider performs matching (allocation) in consideration of information (packages, locations, and so on) received from respective delivery business operators can be considered, but with only information received from respective delivery business operators, indexes for appropriately causing matching are not sufficient from a perspective of performing overall optimization. As a result, it has been considered that providing a vehicle sharing service (in other words, a service for allocating packages to deliver to vehicles) having good delivery efficiency is not possible from a perspective of performing overall optimization.

Accordingly, the present invention has an objective of providing a vehicle allocation system and a vehicle candidate display method which are used to create indexes for, on the basis of obtained information, appropriately performing matching from a perspective of performing overall optimization, and to realize a vehicle sharing service for which delivery efficiency is improved.

According to a first aspect of the present invention, the following vehicle allocation system is provided. In other words, this vehicle allocation system evaluates, in relation to a plurality of delivery vehicles having transportation plans determined in advance, which transportation plan for a delivery vehicle is to be corrected when adding delivery of a new package and displays the evaluation result. The vehicle allocation system includes a processor, a recording unit, and a display apparatus. A vehicle information recording unit configured to record information regarding a delivery vehicle, a cargo information recording unit configured to record information regarding a new delivery package, and an index calculation processing unit configured to calculate a plurality of indexes and execute display of information based on the calculated indexes are disposed as programs in the recording unit. The processor reads the vehicle information recording unit to record information regarding a delivery vehicle in the recording unit, and reads the cargo information recording unit to record information regarding a new delivery package in the recording unit. The processor further reads the index calculation processing unit to, on the basis of information obtained by executing the vehicle information recording unit and the cargo information recording unit, calculate for each delivery vehicle an index pertaining to movement distance, an index pertaining to profit, and an index pertaining to a ratio of loaded travel distance to total travel distance. The processor uses weights on the calculated indexes to calculate for each delivery vehicle an overall index which is an overall index that combines the indexes. The processor causes the display apparatus to display information regarding the index pertaining to movement distance, information regarding the index pertaining to profit, information regarding the index pertaining to the ratio of loaded travel distance to total travel distance, and vehicle allocation candidate information which is information in which the overall indexes for the respective delivery vehicles are lined up in descending order.

According to a second aspect of the present invention, the following vehicle candidate display method is provided. In other words, this vehicle candidate display method evaluates, in relation to a plurality of delivery vehicles having transportation plans determined in advance, which transportation plan for a delivery vehicle is to be corrected when adding delivery of a new package and displays the evaluation result. The vehicle candidate display method uses a processor, a recording unit, and a display apparatus. The recording unit has, disposed therein as programs, a vehicle information recording unit configured to record information regarding a delivery vehicle, a cargo information recording unit configured to record information regarding a new delivery package, and an index calculation processing unit configured to calculate a plurality of indexes and execute display of information based on the calculated indexes. The vehicle candidate display method includes a delivery vehicle information recording step of the processor reading the vehicle information recording unit to record information regarding a delivery vehicle in the recording unit; a cargo information recording step of the processor reading the cargo information recording unit to record information regarding a new delivery package in the recording unit; an index calculation step of the processor reading the index calculation processing unit to, on the basis of information obtained by executing the vehicle information recording unit and the cargo information recording unit, calculate for each delivery vehicle an index pertaining to movement distance, an index pertaining to profit, and an index pertaining to a ratio of loaded travel distance to total travel distance; an overall index calculation step of the processor reading the index calculation processing unit and using weights on the calculated indexes to calculate for each delivery vehicle an overall index which is an overall index that combines the indexes; and a vehicle allocation candidate display step of the processor reading the index calculation processing unit to cause the display apparatus to display information regarding the index pertaining to movement distance, information regarding the index pertaining to profit, information regarding the index pertaining to the ratio of loaded travel distance to total travel distance, and vehicle allocation candidate information which is information in which the overall indexes for the respective delivery vehicles are lined up in descending order.

According to the present invention, a vehicle allocation system and a vehicle candidate display method which are used to create indexes for, on the basis of obtained information, appropriately performing matching from a perspective of performing overall optimization, and to realize a vehicle sharing service for which delivery efficiency is improved are provided.

### BRIEF DESCRIPTION OF THE DRAWINGS

FIG. 1 is a functional block diagram illustrating an overall configuration of a vehicle allocation system according to a first embodiment;

FIG. 2 is a view for describing an example of data recorded in a delivery route recording unit;

FIG. 3 is a view for describing an example of data recorded in a sudden order recording unit;

FIG. 4 is a view for describing an example of data recorded in a location information recording unit;

FIG. 5 is a view that illustrates an example of indexes calculated by execution of an index calculation processing unit;

FIG. 6 is a view for describing an example of data in a case where a sudden order is allocated to a delivery vehicle 1;

FIG. 7 is a view for describing an example of data in a case where a sudden order is allocated to a delivery vehicle 2;

FIG. 8 is a view for describing an example of a method for calculating a total movement distance;

FIG. 9 is a view for describing an example of a method for calculating a profit distribution;

FIG. 10 is a view for describing an example of a method for calculating an average ratio of loaded travel distance to total travel distance;

FIG. 11 is a view for describing an example of a method for calculating an overall index;

FIG. 12 illustrates an example of a high-level display;

FIG. 13 is a view for describing an example of a business flow using the vehicle allocation system according to the first embodiment;

FIG. 14 is a functional block diagram illustrating an overall configuration of a vehicle allocation system according to a second embodiment;

FIG. 15 is a view for describing data recorded in a training data recording unit;

FIG. 16 is a view for describing processing in accordance with execution of a training processing unit;

FIG. 17 is a view for describing an example of a business flow using the vehicle allocation system according to the second embodiment;

FIG. 18 is a view that illustrates an example of a candidate for a delivery plan set up in a case where a sudden order is allocated to a delivery vehicle, according to a third embodiment; and

FIG. 19 is a view that illustrates an example of allocation of a sudden order by a delivery business operator.

### DESCRIPTION OF THE PREFERRED EMBODIMENTS

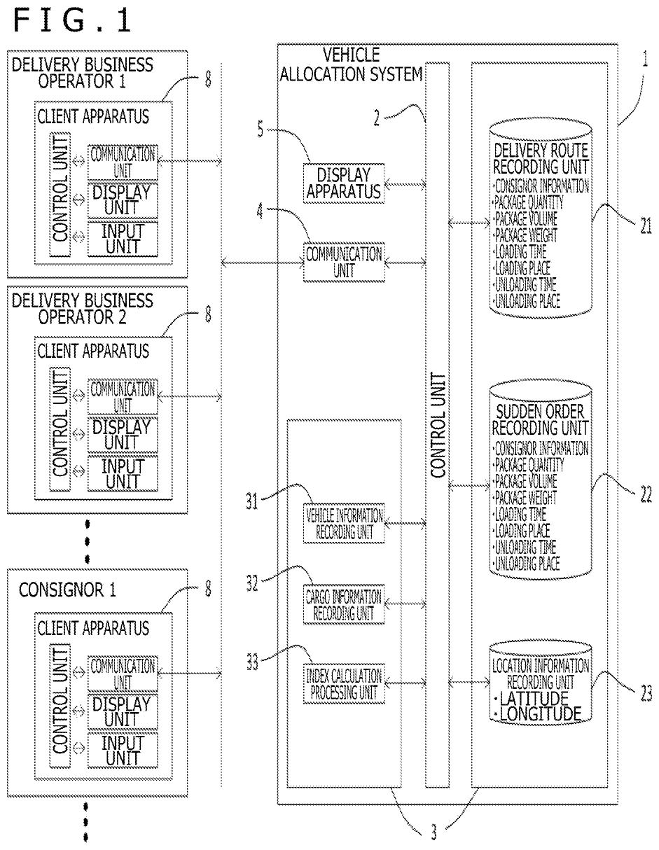

In the embodiments, description is given regarding an example of a vehicle allocation system that can obtain in advance delivery routes for delivery vehicles from a plurality of delivery business operators and, for example, in a case where a sudden delivery order is obtained from a consignor, evaluate which transportation plan for a delivery vehicle is to be corrected and display the evaluation result. FIG. 1 is a functional block diagram illustrating an overall configuration of a vehicle allocation system according to a first embodiment.

A vehicle allocation system 1 is configured as a computer including a control unit 2, a recording unit 3, a communication unit 4, and a display apparatus 5. The control unit 2 is a processor and can be a central processing unit (CPU), for example. The recording unit 3 can be configured using an appropriate recording apparatus that can save a program or data, and can be configured using a hard disk drive (HDD) or a memory, for example. A plurality of programs are disposed in the recording unit 3, as described below. As an example, a program disposed in the recording unit 3 is realized by being read into a memory and being executed by the control unit 2. In addition, the recording unit 3 includes a delivery route recording unit 21, a sudden order recording unit 22, and a location information recording unit 23, which are described below. The communication unit 4 is an interface and has a configuration for performing communication via a network. The vehicle allocation system 1 can receive and obtain information from an external unit in accordance with communication via the communication unit 4. The display apparatus 5 is a display that displays information outputted by the control unit 2.

The vehicle allocation system 1 is inputted with information regarding delivery business operators from computers (client apparatuses 8) of a plurality of delivery business operators, and is inputted with information from consignors from computers (client apparatuses 8) of the consignors. Here, as an example, a client apparatus can have a configuration that includes a control unit, a communication unit, an input unit, and a display unit. The control unit is a processor. The communication unit is an interface for performing communication. The input unit has a configuration for a user to input data. The display unit is a display. Note that the input unit and the display unit may be configured by a touch panel. A client apparatus 8 may be a smartphone, for example.

Next, description is given regarding a program disposed in the recording unit 3 of the vehicle allocation system 1. In the present embodiment, a vehicle information recording unit 31, a cargo information recording unit 32, and an index calculation processing unit 33 are disposed as programs in the recording unit 3.

The vehicle information recording unit 31 is a program used to record information regarding delivery vehicles (is a program used in a delivery vehicle information recording step). The vehicle information recording unit 31, for example, is used to obtain and record information regarding delivery vehicles transmitted from the client apparatus 8 of a delivery business operator. The control unit 2 of the vehicle allocation system 1, by reading and executing the vehicle information recording unit 31, obtains the information regarding the delivery vehicles (such as information regarding a transportation plan for a vehicle), and records the obtained information in the recording unit 3.

The cargo information recording unit 32 is a program used to obtain and record information regarding a new delivery package (is a program used in a cargo information recording step). The cargo information recording unit 32, for example, is used to obtain and record information regarding a sudden order transmitted from the client apparatus 8 of a consignor. In this case, the control unit 2 of the vehicle allocation system 1, by reading and executing the cargo information recording unit 32, obtains information (such as information regarding a package to deliver) from the consignor, and records the obtained information in the recording unit 3.

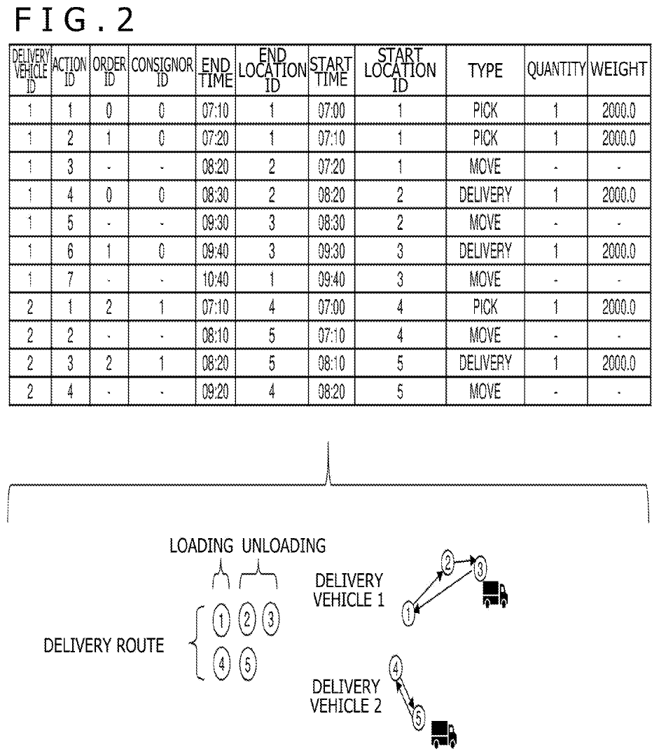

Here, in the present embodiment, description is given regarding an example of data recorded in the recording unit 3 by execution of the vehicle information recording unit 31 and the cargo information recording unit 32 described above. First, description is given regarding an example of data recorded in the delivery route recording unit 21 of the recording unit 3. FIG. 2 is a view for describing an example of data recorded in the delivery route recording unit.

Information regarding a transportation plan for a delivery vehicle is recorded in the delivery route recording unit 21. Specifically, as illustrated in FIG. 2, data pertaining to a delivery vehicle identifier (ID), an action ID, an order ID, a consignor ID, an end time, an end location ID, a start time, a start location ID, a type, a quantity, and a weight is recorded in the delivery route recording unit 21. Note that FIG. 2 is an example, and for example, other information such as information for identifying the size of a package or which delivery business operator the delivery vehicle belongs to may be included. Here, information for identifying which delivery business operator the delivery vehicle belongs to can be, for example, an ID which differs for each delivery business operator.

The delivery vehicle ID is an ID for identifying a delivery vehicle, and a different ID is assigned for each delivery vehicle. Note that natural numbers are used as an example here in order to distinguish from delivery vehicle IDs for data recorded in the sudden order recording unit 22 to be described below. The action ID is an ID which represents a stage in a work process, and a different action ID is assigned for each stage. The order ID is a specific identification ID assigned to a package to be delivered, and a different ID is assigned to each package to be delivered. The consignor ID is an ID for identifying the consignor ID of a package, and a different ID is assigned for each consignor. The end time is a scheduled time for the work of each stage included in the work process to end. The end location ID is an ID which indicates the location where the work is to end, and a different ID is assigned to each location. The start time is a scheduled time for the work of each stage included in the work process to start. The start location ID is an ID which indicates the location where the work is to start, and a different ID is assigned to each location. The type represents a type of work. In the data illustrated in FIG. 2, three types of work: “loading” (PICK), “movement” (MOVE), and “unloading” (DELIVERY) are exemplified. The quantity is the number of packages handled when performing work (loading and unloading). The weight is the weight of the packages in accordance with the quantity.

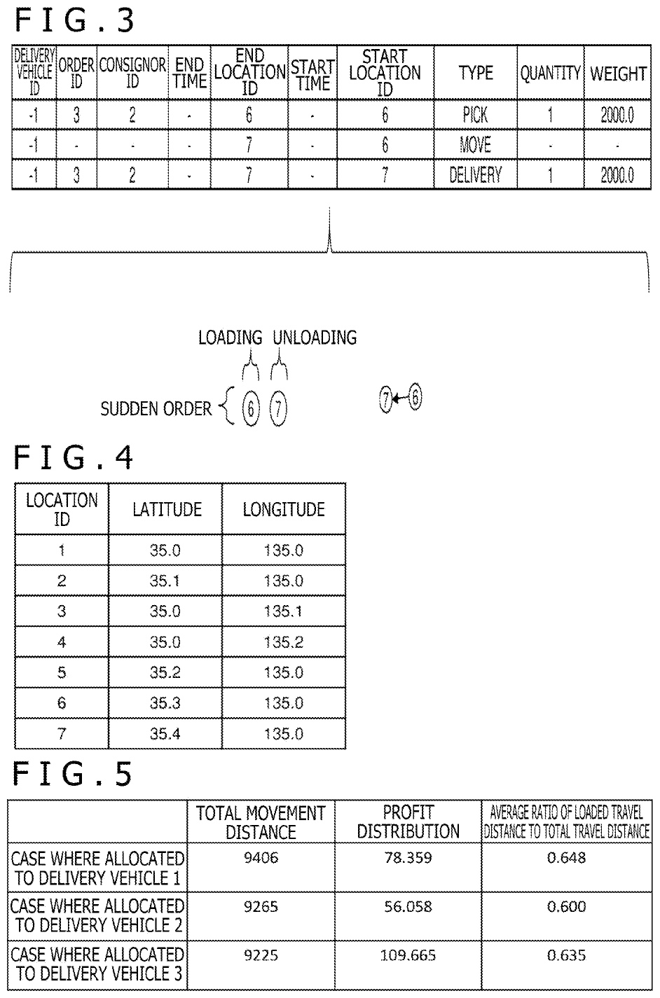

Next, description is given regarding an example of data recorded in the sudden order recording unit 22 of the recording unit 3. FIG. 3 is a view for describing an example of data recorded in the sudden order recording unit.

Information regarding a sudden package delivery request (sudden order) from a consignor, for example, is recorded in the sudden order recording unit 22. As illustrated in FIG. 3, data pertaining to a delivery vehicle ID, an order ID, a consignor ID, an end time, an end location ID, a start time, a start location ID, a type, a quantity, and a weight is recorded in the sudden order recording unit 22. Note that FIG. 3 is an example, and for example, other information such as the size of a package may be included.

The delivery vehicle ID is indicated as a negative number as an example in the present embodiment in order to be distinguished from data recorded in the delivery route recording unit 21 described above. Times are not set because the end time of work and the start time of work are unclear. The order ID, the consignor ID, the end location ID, the start location ID, the type, the quantity, and the weight have the same meanings as in the case described in the example of data recorded in the delivery route recording unit 21 described above, and thus description thereof is omitted.

Next, description is given regarding an example of data recorded in the location information recording unit 23 of the recording unit 3. FIG. 4 is a view for describing an example of data recorded in the location information recording unit.

Information regarding a location where work (in the present embodiment, loading and unloading) is performed, the information being obtained by execution of the vehicle information recording unit 31 or the cargo information recording unit 32, is recorded in the location information recording unit 23. As illustrated in FIG. 4, data pertaining to a location ID, a latitude, and a longitude is recorded in the location information recording unit 23. The location ID is an ID assigned for each work location for a delivery vehicle. The latitude is the latitude of the work location indicated by the location ID. The longitude is the longitude of the work location indicated by the location ID.

Next, description is given regarding the index calculation processing unit 33 which is a program. The index calculation processing unit 33 is used to perform processing for calculating a plurality of indexes (in other words, is used in an index calculation step), using data recorded in the delivery route recording unit 21, the sudden order recording unit 22, and the location information recording unit 23 described above. In the present embodiment, the control unit 2 of the vehicle allocation system 1 executes the index calculation processing unit 33 to thereby calculate “total movement distance,” “profit distribution,” and “average ratio of loaded travel distance to total travel distance” as a plurality of indexes, as illustrated in FIG. 5. Description is given below regarding methods of processing for calculating the “total movement distance,” the “profit distribution,” and the “average ratio of loaded travel distance to total travel distance.”

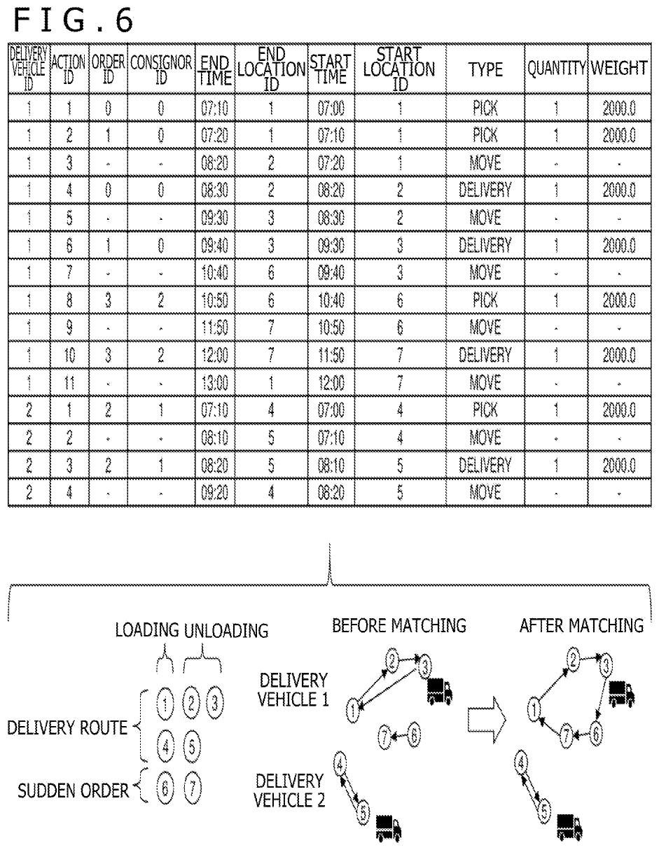

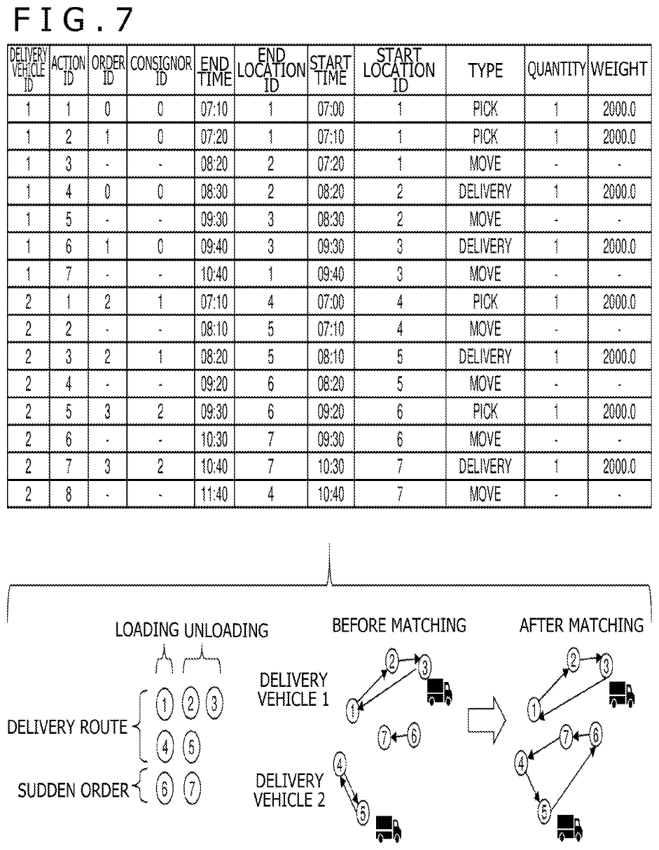

In the processing for calculating indexes by the index calculation processing unit 33, index values are calculated for a case of allocating data recorded in the sudden order recording unit 22 (in other words, delivery of a package according to a sudden order) to each delivery vehicle. At this time, the processing for calculating the indexes is executed by using data resulting from combining data recorded in the sudden order recording unit 22 and data recorded in the delivery route recording unit 21. Description is first given regarding this processing while referring to FIGS. 6 and 7. FIG. 6 is a view for giving a description regarding data in the case of allocating to a delivery vehicle 1. FIG. 7 is a view for giving a description regarding data in the case of allocating to a delivery vehicle 2.

As illustrated in FIG. 6, in the case of allocating (referred to as “matching” in FIG. 6) a sudden order to the delivery vehicle 1, as an example, the following details are added to data pertaining to the delivery vehicle 1. In other words, moving on after work at the location with the end location ID of 3 has ended, the location with the end location ID of 6 is arrived at. Then, moving on after work at this location has ended, the location with the end location ID of 7 is arrived at. Subsequently, moving on after work at this location has ended, the location with the end location ID of 1 is arrived at. In addition, an action ID is assigned to details that are added.

As illustrated in FIG. 7, in the case of allocating (referred to as “matching” in FIG. 7) a sudden order to the delivery vehicle 2, as an example, the following details are added to data pertaining to the delivery vehicle 2. In other words, moving on after work at the location with the end location ID of 5 has ended, the location with the end location ID of 6 is arrived at. Then, moving on after work at this location has ended, the location with the end location ID of 7 is arrived at. Subsequently, moving on after work at this location has ended, the location with the end location ID of 4 is arrived at. In addition, an action ID is assigned to details that are added.

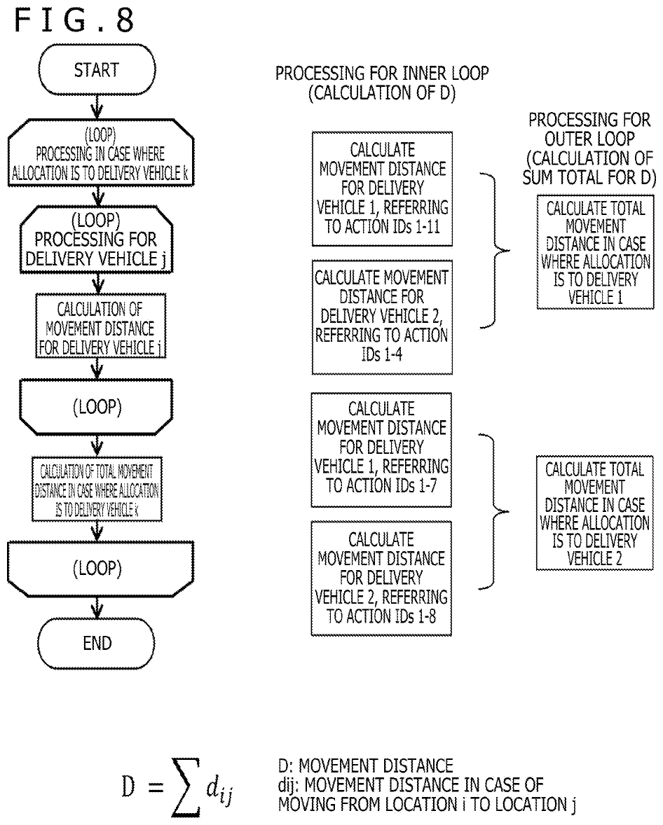

Next, in addition to the details described above, while referring to FIG. 8 as well, description is given regarding an example of a method of calculating an index for the “total movement distance.” FIG. 8 is a view for describing an example of a method for calculating the total movement distance.

As illustrated in FIG. 8, when calculating the “total movement distance,” a movement distance D of each delivery vehicle is calculated (inner loop of flow chart). In other words, in the case of allocating a sudden order to the delivery vehicle 1, the movement distance D for where the action ID is 1 to 11 (in other words, the total movement distance in moving from a certain location to another location in work with the action ID 1 to 11) is calculated for the delivery vehicle 1, and the movement distance D for where the action ID is 1 to 4 is calculated for the delivery vehicle 2. Next, in accordance with the sum total of the calculated movement distance D of each delivery vehicle being calculated (in other words, summing the D values for respective delivery vehicles), the “total movement distance” in the case of allocating the sudden order to one delivery vehicle among a plurality of delivery vehicles is calculated (outer loop of flow chart).

Here, in the calculation process for the inner loop of the flow chart (in other words, the processing for calculating the movement distance D), the calculation method is not particularly limited if it is possible to appropriately calculate the movement distance D. In the processing by the index calculation processing unit 33 according to the control unit 2 of the vehicle allocation system 1, as an example, a method such as the following may be used to calculate the movement distance D. For example, Google Maps application programming interface (API) may be used to calculate the movement distance D. In addition, as a method of simply estimating distance, the movement distance D may be calculated by using the Euclidean distance or the Manhattan distance between the latitude and longitude of a start location and the latitude and longitude of an end location.

Note that, although it is sufficient if the “total movement distance” can be appropriately calculated, the “total movement distance” is an index for which consideration is desirable from a viewpoint of resource saving. In the present embodiment, in this manner, it is possible to calculate the “total movement distance” by processing the coordinates of a delivery destination.

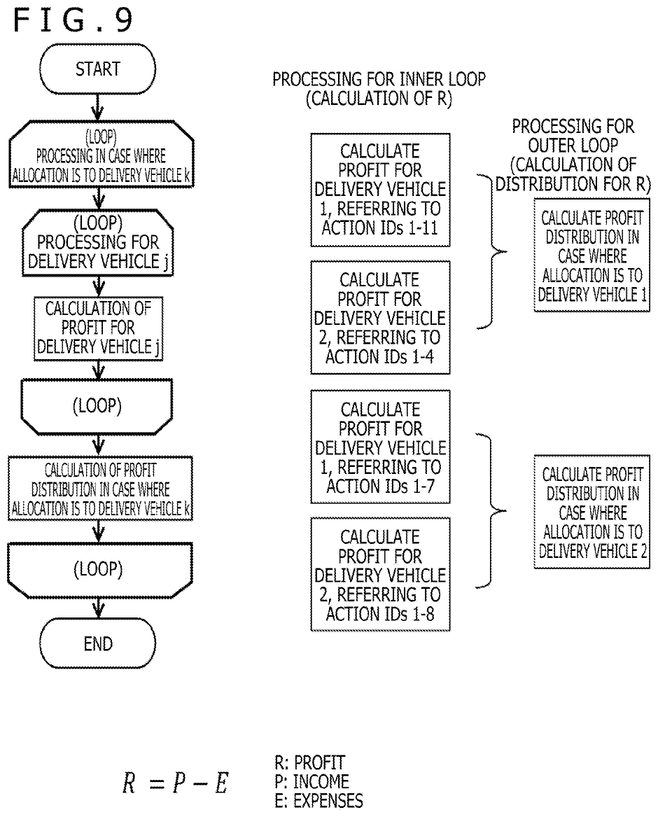

Next, while referring to FIG. 9, description is given regarding an example of a method for calculating the “profit distribution” index. FIG. 9 is a view for describing an example of a method for calculating a profit distribution.

As illustrated in FIG. 9, when calculating the “profit distribution,” the profit R of each delivery vehicle is calculated (inner loop in flow chart). In other words, in the case of allocating a sudden order to the delivery vehicle 1, the profit R for where the action ID is 1 to 11 is calculated for the delivery vehicle 1, and the profit R for where the action ID is 1 to 4 is calculated for the delivery vehicle 2. In accordance with a distribution of the calculated profit R for each delivery vehicle being calculated (in other words, by calculating a distribution from the values of R for respective delivery vehicles), the “profit distribution” in the case of allocating the sudden order to one delivery vehicle among a plurality of delivery vehicles is calculated (outer loop of flow chart).

Here, in the calculation process for the inner loop of the flow chart (in other words, the processing for calculating the profit R), the calculation method is not particularly limited if it is possible to appropriately calculate the profit R. In the processing by the index calculation processing unit 33 according to the control unit 2 of the vehicle allocation system 1, as an example, a method such as the following may be used to calculate the profit R. In other words, the profit R can be defined as the difference between income P and expenses E. The income P, for example, is defined in accordance with a fare table determined by the weight of a package and the movement distance D. Note that, as a method of simply estimating the income P, a method in which the income P is set to the number of packages can be considered. Meanwhile, it can be considered that the expenses E are defined mainly based on a gasoline fee due to movement. Note that, as a method of simply estimating the expenses E, a method of setting the expenses E to the movement distance D can be considered. The profit R is calculated from the difference between the income P and the expenses E as described above.

Note that, although it is sufficient if the “profit distribution” can be appropriately calculated, the “profit distribution” is an index for which consideration is desirable from a viewpoint of fairness. In the present embodiment, in this manner, it is possible to calculate the “profit distribution” by processing cargo information (in other words, information regarding cargo, such as load amount, loading rate, package weight, or number of packages) of a delivery vehicle, and processing coordinates of a delivery destination.

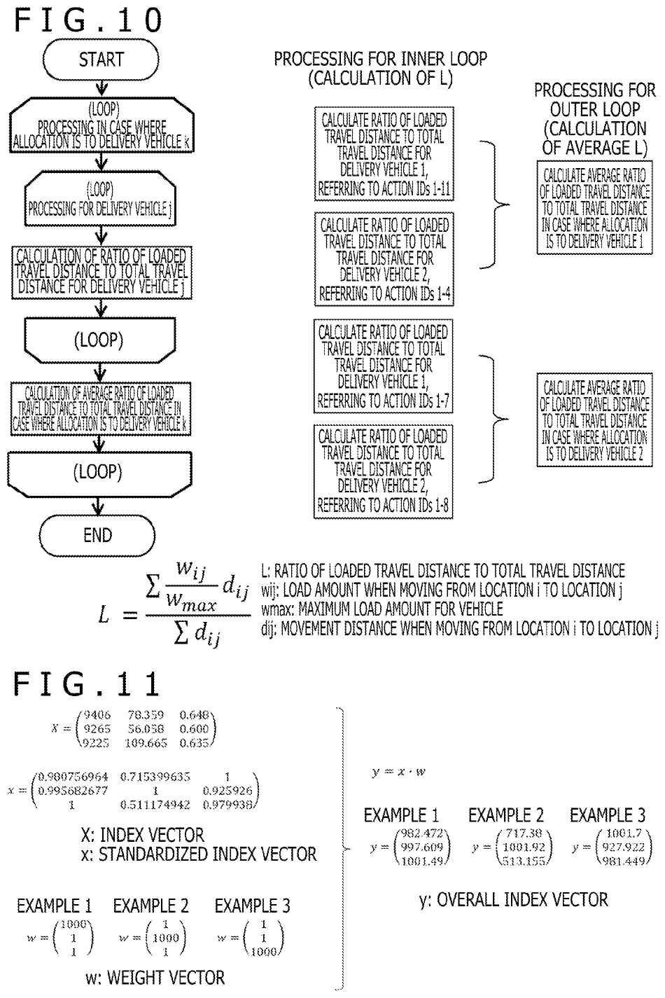

Next, while referring to FIG. 10, description is given regarding an example of a method for calculating the “average ratio of loaded travel distance to total travel distance” index. FIG. 10 is a view for describing an example of a method for calculating an average ratio of loaded travel distance to total travel distance. Note that the ratio of loaded travel distance to total travel distance means delivery efficiency.

As illustrated in FIG. 10, when calculating the “average ratio of loaded travel distance to total travel distance,” a ratio L of loaded travel distance to total travel distance of each delivery vehicle is calculated (inner loop of flow chart). In other words, in the case of allocating a sudden order to the delivery vehicle 1, the ratio L of loaded travel distance to total travel distance for where the action ID is 1 to 11 is calculated for the delivery vehicle 1, and the ratio L of loaded travel distance to total travel distance for where the action ID is 1 to 4 is calculated for the delivery vehicle 2. In accordance with an average being calculated from the calculated ratio L of loaded travel distance to total travel distance of each delivery vehicle (in other words, by calculating an average using the value of L for each delivery vehicle), the “average ratio of loaded travel distance to total travel distance” in a case where a sudden order is allocated to one delivery vehicle among a plurality of delivery vehicles is calculated (outer loop of flow chart).

Note that, in the calculation process for the inner loop of the flow chart (in other words, the processing for calculating the ratio L of loaded travel distance to total travel distance), the calculation method is not particularly limited if it is possible to appropriately calculate the ratio L of loaded travel distance to total travel distance. In the present embodiment, in the processing by the index calculation processing unit 33 according to the control unit 2 of the vehicle allocation system 1, the ratio L of loaded travel distance to total travel distance is calculated in accordance with a method that uses an equation indicated in FIG. 10. In other words, as illustrated in FIG. 10, the ratio L of loaded travel distance to total travel distance is calculated using a movement distance d and a load amount. Here, wᵢⱼ in the equation indicated in FIG. 10 is the load amount of a delivery vehicle in the case of moving from a certain location to the next location. wₘₐₓ is the maximum load amount for the delivery vehicle. dᵢⱼ is the movement distance d in the case of moving from the certain location to the next location.

Although it is sufficient if the “average ratio of loaded travel distance to total travel distance” can be appropriately calculated, the “average ratio of loaded travel distance to total travel distance” is an index for which consideration is desirable from a viewpoint of effective use of resources. In the present embodiment, in this manner, it is possible to calculate the “average ratio of loaded travel distance to total travel distance” by processing cargo information of a delivery vehicle and processing coordinates of a delivery destination.

The index calculation processing unit 33 is used to perform processing for calculating an overall index that combines a plurality of indexes (in other words, is used in an overall index calculation step). In the present embodiment, the control unit 2 of the vehicle allocation system 1 reads the index calculation processing unit 33 and uses the “total movement distance,” “profit distribution,” and “average ratio of loaded travel distance to total travel distance,” which are indexes described above, to calculate an overall index that combines these indexes. While referring to FIG. 11, description is given below regarding a method of calculating the overall index. FIG. 11 is a view for describing an example of a method for calculating the overall index.

FIG. 11 illustrates, in accordance with an index vector X (a matrix), values for indexes set for each delivery vehicle (in other words, values of indexes obtained by allocating a sudden order to each delivery vehicle). In the calculation of the overall index using the index calculation processing unit 33, standardization of the indexes is first performed. Note that it is sufficient if the standardization can be appropriately performed in consideration of properties of an index. In the present embodiment, it is considered that the smaller the values of “total movement distance” and “profit distribution” are the better they are, and the “total movement distance” and the “profit distribution” are standardized by taking an inverse and multiplying by a minimum value. For example, in the standardization in the example of FIG. 11, a value for the “total movement distance” of the delivery vehicle 1 is obtained by multiplying the inverse of 9406 by 9225, and a value for the “profit distribution” of the delivery vehicle 1 is obtained by multiplying the inverse of 78.359 by 56.058. In contrast, it is considered that the larger a value for the “average ratio of loaded travel distance to total travel distance” is the better it is, and the “average ratio of loaded travel distance to total travel distance” is standardized by dividing by a maximum value. For example, in the standardization in the example in FIG. 11, a value for the “average ratio of loaded travel distance to total travel distance” of the delivery vehicle 2 is obtained by dividing 0.600 by 0.648.

The overall index is calculated using weights on standardized indexes. In FIG. 11, an example of weights is indicated by a weight vector w (a row vector). Here, example 1 is an example in which the weight of the “total movement distance” is increased. Example 2 is an example in which the weight of the “profit distribution” is increased. Example 3 is an example in which the weight of the “average ratio of loaded travel distance to total travel distance” is increased.

Here, as an example, a weight can be a value set by an operator. An operator can appropriately set a weight in consideration of, for example, a delivery status. For example, in a case where operation time periods are long with just existing deliveries in relation to all delivery vehicles due to a busy season or the like, from a viewpoint such as the risk of an accident due to driver fatigue or abiding by constraints in the Labor Standards Act of Japan, it is possible to set the weight of the “total movement distance” to a high value in order to perform allocation to a delivery vehicle with a short movement distance. In this manner, the operator can simply weight indexes in alignment with feelings.

The overall index (overall index vector y) is calculated in accordance with the product of the standardized indexes (the standardized index vector x) and the weights (weight vector w). In FIG. 11, example 1 is where the weight of the “total movement distance” is increased, and the value is a maximum in a case where a sudden order is allocated to the delivery vehicle 3. Example 2 is where the weight of the “profit distribution” is increased, and the value is a maximum in a case where a sudden order is allocated to the delivery vehicle 2. Example 3 is where the weight of the “average ratio of loaded travel distance to total travel distance” is increased, and the value is a maximum in a case where a sudden order is allocated to the delivery vehicle 1.

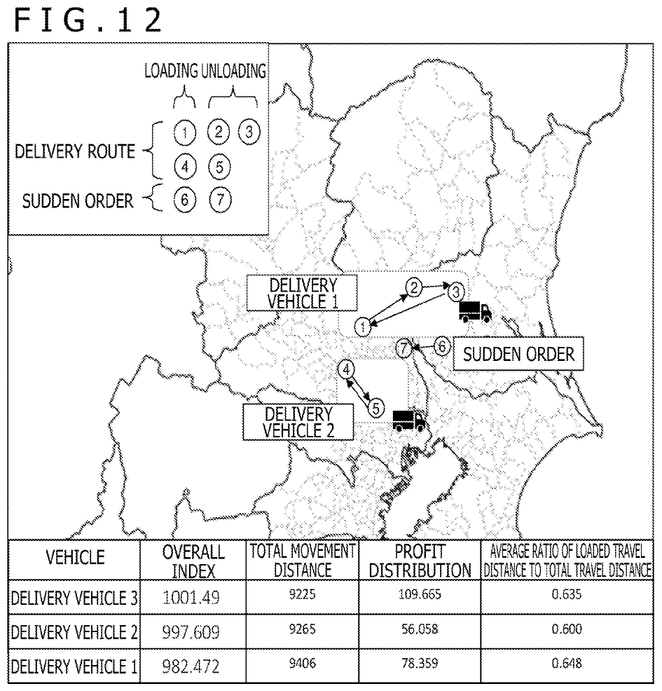

In addition, the index calculation processing unit 33 is used in processing for generating display data for causing the display apparatus 5 to display the calculated overall index and the indexes used in the calculation thereof, and performing a display based on the display data (in other words, is used in a vehicle allocation candidate display step). In this processing, it is possible to record the generated display data in the recording unit 3 and perform a display based on the display data which has been recorded in the recording unit 3. Next, while referring to FIG. 12, description is given regarding an example of a display screen which is displayed by the display apparatus 5. FIG. 12 illustrates an example of a high-level display.

As illustrated in FIG. 12, information in which the overall indexes for the respective delivery vehicles are lined up in descending order (vehicle allocation candidate information) is displayed on the display apparatus 5. In other words, information regarding delivery vehicles is displayed in an order suitable for being corrected (in other words, in descending order of the value of overall index). In addition to this, values for the plurality of indexes (“total movement distance,” “profit distribution,” and “average ratio of loaded travel distance to total travel distance” in the present embodiment) used to calculate the overall index are displayed for each delivery vehicle. In addition, information regarding delivery routes for delivery vehicles, and a sudden order are displayed on the display apparatus 5. Note that, in FIG. 12, a case for the overall index example 1 illustrated in FIG. 11 is displayed.

As illustrated in FIG. 12, map information may be displayed on the display apparatus 5. In addition, the present location of a delivery vehicle may be displayed on the display apparatus 5, by using a symbol. Here, the symbol indicating the present location of a delivery vehicle may be displayed so as to overlap the map information. Note that the present location of a delivery vehicle can be obtained by referring to data recorded in the delivery route recording unit 21, for example. In addition, location information obtained using a global positioning system (GPS) apparatus may be obtained from the delivery vehicle, and a symbol is displayed at the obtained location.

There is no limitation to the display mode illustrated in FIG. 12, and the display mode can be changed as appropriate. For example, a graphical display using a plurality of colors may be performed, and a display that facilitates distinguishing between the delivery routes for the respective delivery vehicles may be performed by using colors that differ for each delivery route. In addition, a display that facilitates distinguishing information regarding delivery routes and information regarding sudden orders from each other by using different colors or symbols to represent information regarding delivery routes of delivery vehicles and information regarding sudden orders may be performed. For example, although information regarding delivery routes and sudden orders are represented by circle symbols and Arabic numerals in FIG. 12, it may be that circle symbols are used for information regarding delivery routes and square symbols are used for information regarding sudden orders. In addition, text information, symbol information, or the like that is not in FIG. 12 may be used as appropriate.

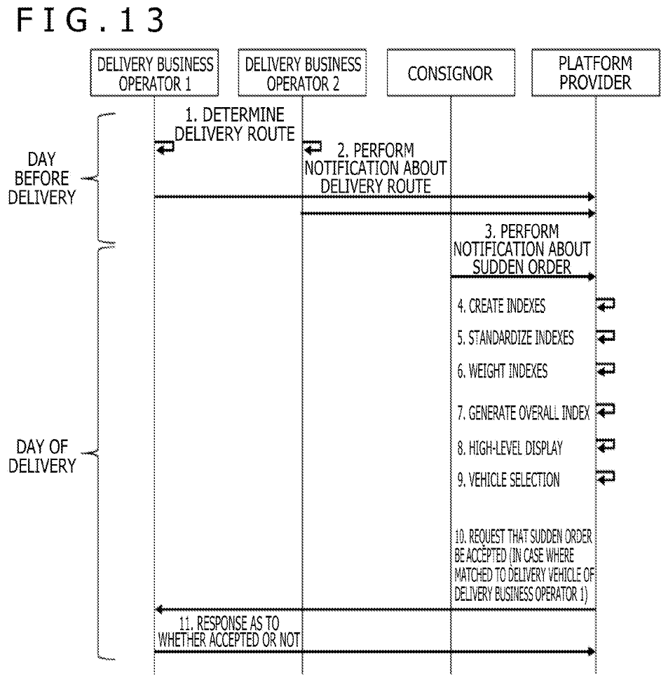

Next, description is given regarding an example of a business flow that uses the vehicle allocation system 1 (in other words, an example of a vehicle sharing service). FIG. 13 is a view for describing an example of a business flow using the vehicle allocation system.

In the example of FIG. 13, a platform provider uses the vehicle allocation system 1. Each delivery business operator determines in advance (in this example, on the day before delivery) the delivery routes for their own delivery vehicles (a delivery route also includes information regarding work details for that day), and notifies in advance the platform provider of the delivery route for each delivery vehicle. Note that, as described above, because the client apparatuses 8 can each communicate with the vehicle allocation system 1 via the communication unit 4 of the vehicle allocation system 1, it is possible to directly transmit a delivery route to the vehicle allocation system 1, but a delivery route may be inputted to the vehicle allocation system 1 by an operator on the platform provider side. In this case, a user interface (for example, an operation device such as a keyboard) appropriate for the operator to input a delivery route is provided in the vehicle allocation system 1.

On the day of delivery, for example, a sudden order from a consignor is notified to the platform provider. In the case where such a sudden order is notified, the control unit 2 of the vehicle allocation system 1 executes the index calculation processing unit 33 to calculate an overall index (in other words, calculates a plurality of indexes, standardizes the calculated indexes, and uses weights to calculate the overall index), and performs display based on the calculated overall index on the display apparatus 5. Note that, similarly to a case in which a delivery business operator performs notification about a delivery route, information from a consignor may be directly transmitted to the vehicle allocation system 1, or an operator may input information from a consignor to the vehicle allocation system 1.

The operator refers to information displayed on the display apparatus 5, and selects a delivery vehicle (in other words, a vehicle to which delivery pertaining to the sudden order is to be allocated) for which the transportation plan (in other words, the delivery route) is to be corrected. At this time, the operator can make a selection while referring to, for example, information (vehicle allocation candidate information) in which the overall indexes for the respective delivery vehicles are lined up in descending order. A request to accept a sudden order is made to a delivery business operator selected by the operator, and the delivery business operator having received a notification makes a response pertaining to whether or not they will accept delivery for the sudden order. Note that the request to accept a sudden order may be performed by a direct method by the operator (for example, by email or telephone), or it may be that an appropriate user interface into which a selection by the operator is inputted (for example, an operation device such as a keyboard) is provided in the vehicle allocation system 1 and the vehicle allocation system 1 automatically performs a notification to a selected delivery business operator.

In this manner, because the vehicle allocation system 1 can cause display of information resulting from evaluating allocation of the sudden order (for example, overall index or indexes), the operator can, in a visualized state, select a delivery vehicle for which to correct the transportation plan.

In accordance with the above description, the following vehicle allocation system 1 can be provided. In other words, the vehicle allocation system 1 evaluates, in relation to a plurality of delivery vehicles having transportation plans determined in advance, which transportation plan for a delivery vehicle is to be corrected when adding delivery of a new package and displays the evaluation result. The vehicle allocation system 1 includes the processor (control unit 2), the recording unit 3, and the display apparatus 5. The vehicle information recording unit 31 which records information regarding delivery vehicles, the cargo information recording unit 32 which records information regarding new delivery packages, and the index calculation processing unit 33 which calculates a plurality of indexes and executes display of information based on the calculated indexes are disposed as programs in the recording unit 3. The processor reads the vehicle information recording unit 31 to record information regarding a delivery vehicle in the recording unit 3, and reads the cargo information recording unit 32 to record information regarding a new delivery package in the recording unit 3. The processor further reads the index calculation processing unit 33 to, on the basis of information obtained by executing the vehicle information recording unit 31 and the cargo information recording unit 32, calculate for each delivery vehicle an index pertaining to the movement distance D, an index pertaining to the profit R, and an index pertaining to the ratio L of loaded travel distance to total travel distance. The processor uses weights on the calculated indexes to calculate for each delivery vehicle an overall index which is an overall index that combines the indexes. The processor causes the display apparatus 5 to display the index pertaining to the movement distance D, the index pertaining to the profit R, the index pertaining to the ratio L of loaded travel distance to total travel distance, and vehicle allocation candidate information which is information in which the overall indexes for the respective delivery vehicles are lined up in descending order.

As a result, the vehicle allocation system 1, which is used to create indexes for, on the basis of obtained information, appropriately performing matching from a perspective of performing overall optimization and to realize a vehicle sharing service for which delivery efficiency is improved, is provided.

In addition, in the present embodiment, it is possible to select a delivery vehicle by simply weighting indexes in alignment with an operator's feelings.

In addition, the following vehicle candidate display method is provided. In other words, this vehicle candidate display method is a vehicle candidate display method for evaluating, in relation to a plurality of delivery vehicles having transportation plans determined in advance, which transportation plan for a delivery vehicle is to be corrected when adding delivery of a new package, and displaying the evaluation result. The vehicle candidate display method uses the processor (control unit 2), the recording unit 3, and the display apparatus 5. The recording unit 3 has, disposed therein as programs, the vehicle information recording unit 31 configured to record information regarding a delivery vehicle, the cargo information recording unit 32 configured to record information regarding a new delivery package, and the index calculation processing unit 33 configured to calculate a plurality of indexes and execute display of information based on the calculated indexes. The vehicle candidate display method includes: a delivery vehicle information recording step of the processor reading the vehicle information recording unit 31 to record information regarding a delivery vehicle in the recording unit 3; a cargo information recording step of the processor reading the cargo information recording unit 32 to record information regarding a new delivery package in the recording unit 3; an index calculation step of the processor reading the index calculation processing unit 33 to, on the basis of information obtained by executing the vehicle information recording unit 31 and the cargo information recording unit 32, calculate for each delivery vehicle an index pertaining to the movement distance D, an index pertaining to the profit R, and an index pertaining to the ratio L of loaded travel distance to total travel distance; an overall index calculation step of the processor reading the index calculation processing unit 33 and using weights on the calculated indexes to calculate for each delivery vehicle an overall index which is an overall index that combines the indexes; and a vehicle allocation candidate display step of the processor reading the index calculation processing unit 33 to cause the display apparatus 5 to display information regarding the index pertaining to the movement distance D, information regarding the index pertaining to the profit R, information regarding the index pertaining to the ratio L of loaded travel distance to total travel distance, and vehicle allocation candidate information which is information in which the overall indexes for the respective delivery vehicles are lined up in descending order.

As a result, a vehicle candidate display method, which is used to create indexes for, on the basis of obtained information, appropriately performing matching from a perspective of performing overall optimization and to realize a vehicle sharing service for which delivery efficiency is improved, is provided.

In addition, the following information provision method (in other words, a vehicle sharing service method) is provided using the vehicle allocation system 1. This information provision method includes a delivery vehicle information obtainment step of using the vehicle allocation system 1 to obtain information regarding a delivery vehicle in advance; a cargo information obtainment step of obtaining, on the day of delivery, information regarding a new delivery package; a determination step of, on the basis of information displayed on the vehicle allocation system 1, selecting and determining a delivery vehicle for which to correct a transportation plan; and a notification step of notifying the delivery vehicle for which to correct the transportation plan, or a delivery business operator.

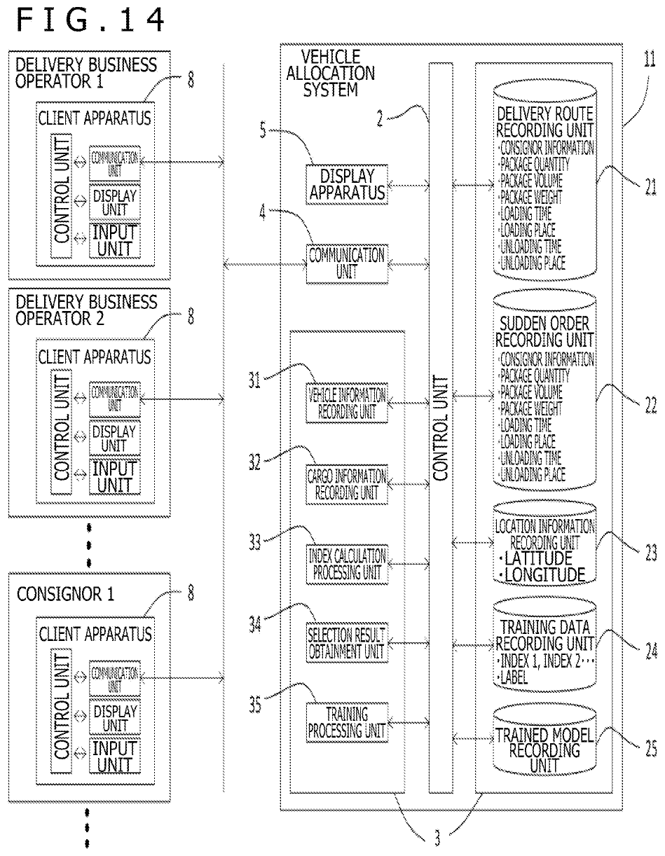

Next, while referring to FIG. 14, description is given regarding a vehicle allocation system 11 according to a second embodiment. FIG. 14 is a functional block diagram illustrating an overall configuration of a vehicle allocation system according to the second embodiment.

In the second embodiment, differing from the case of the first embodiment, the vehicle allocation system 11 includes a selection result obtainment unit 34, a training processing unit 35, a training data recording unit 24, and a trained model recording unit 25 and is capable of generating a trained model and performing processing to calculate an overall index. Here, the selection result obtainment unit 34 and the training processing unit 35 are programs used in this processing. The training data recording unit 24 and the trained model recording unit 25 are included in the recording unit 3 of the vehicle allocation system 11. Information used in this processing is recorded in the training data recording unit 24 and the trained model recording unit 25. Note that, across different drawings, a common reference symbol is used for the same part or a part having a similar function to that in the embodiment described above, and duplicate description thereof is omitted.

The selection result obtainment unit 34 is used for obtaining and recording information regarding a plurality of indexes and a delivery vehicle for which a transportation plan has been corrected. In other words, the selection result obtainment unit 34 is used for obtaining and recording information regarding each index used to calculate the overall index and a delivery vehicle for which to correct a transportation plan and which is determined by an operator with reference to the overall index. Processing by the selection result obtainment unit 34 is executed by the control unit 2 of the vehicle allocation system 11, and the control unit 2 of the vehicle allocation system 11 records the obtained information in the training data recording unit 24.

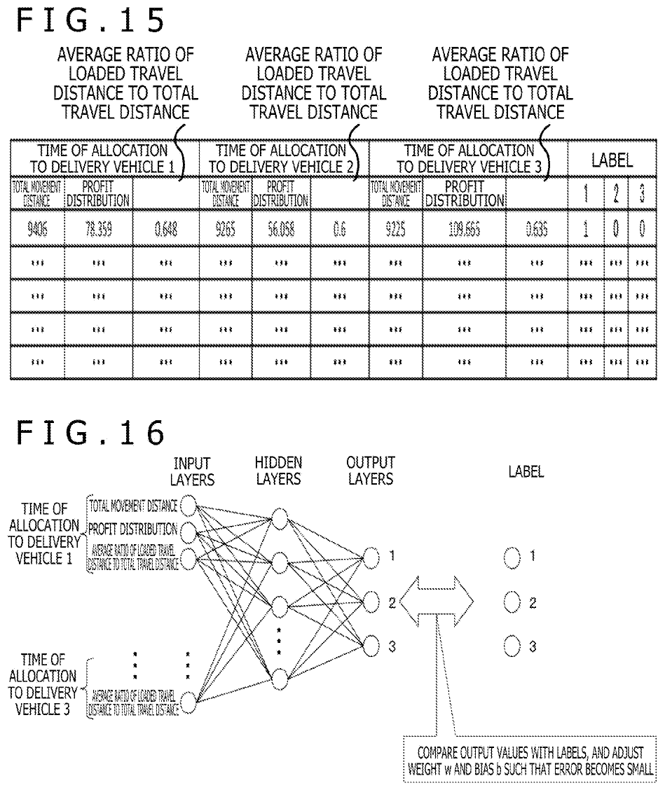

The information recorded in the training data recording unit 24 by execution of the selection result obtainment unit 34 is used as teaching data (training data) for what is generally called supervised learning. As illustrated in FIG. 15, this information (training data) includes information regarding an index value for each delivery vehicle and a delivery vehicle (label) for which to correct a transportation plan as determined by an operator. In the example of FIG. 15, exemplification is given regarding a case in which the transportation plan of the delivery vehicle 1 has been corrected. Note that, in the teaching data of FIG. 15, the case in which the delivery vehicle 1 is selected is exemplified with a label 1 being 1 and other labels (labels 2 and 3) being 0.

The training processing unit 35 is used to, using the information recorded in the training data recording unit 24, generate a trained model for, in response to input of a plurality of indexes, causing output of a delivery vehicle for which correction of the transportation plan is probable. In the present embodiment, as illustrated in FIG. 16, by execution of the training processing unit 35 by the control unit 2 of the vehicle allocation system 11, a trained model is generated. In this trained model, by values for indexes (“total movement distance,” “profit distribution,” and “average ratio of loaded travel distance to total travel distance” in the present embodiment) for each delivery vehicle being inputted to input layers, a delivery vehicle for which correction of a transportation plan is probable is outputted from output layers.

In addition, in the present embodiment, output values and labels are compared (in other words, a comparison is made between estimated outputs from the trained model and correct answers), and adjustments are made such that error becomes small (in other words, such that it is possible to make a more probable output). As an adjustment method, as an example, a method of adjusting weights between neurons and biases is known. In the present embodiment, the control unit 2 of the vehicle allocation system 11 executes the training processing unit 35 to find, by using gradient descent or the like, a solution having a minimum error function and adjust the weights between neurons and biases. Note that it is sufficient if appropriate adjustment is possible (in other words, it is sufficient if adjustment is performed such that a more accurate output can be achieved from the trained model), and the adjustment method is not limited to methods described here.

In addition, in the present embodiment, the training processing unit 35 is used to estimate, by an appropriate method, weights of the respective indexes (in other words, weights caused to act on indexes when calculating the overall index) from the weights of the trained model (in other words, the weights between neurons). In the present embodiment, the control unit 2 of the vehicle allocation system 11 executes the training processing unit 35 to estimate the weights of the respective indexes from the weights between neurons in a case where the error function is minimized in accordance with gradient descent or the like. The weights of the respective indexes, which have been estimated by execution of the training processing unit 35 by the control unit 2 of the vehicle allocation system 11, are recorded in the trained model recording unit 25.

In the present embodiment, the index calculation processing unit 33 may be used to calculate the overall index, using the weights of the respective indexes recorded in the trained model recording unit 25. The control unit 2 of the vehicle allocation system 11 can, by execution of the index calculation processing unit 33, calculate the overall index by using the weights of the respective indexes which are recorded in the trained model recording unit 25.

Note that the training processing unit 35 may be used to record a generated trained model in the trained model recording unit 25, and the control unit 2 of the vehicle allocation system 11 can, by execution of the training processing unit 35, record the generated trained model in the trained model recording unit 25.

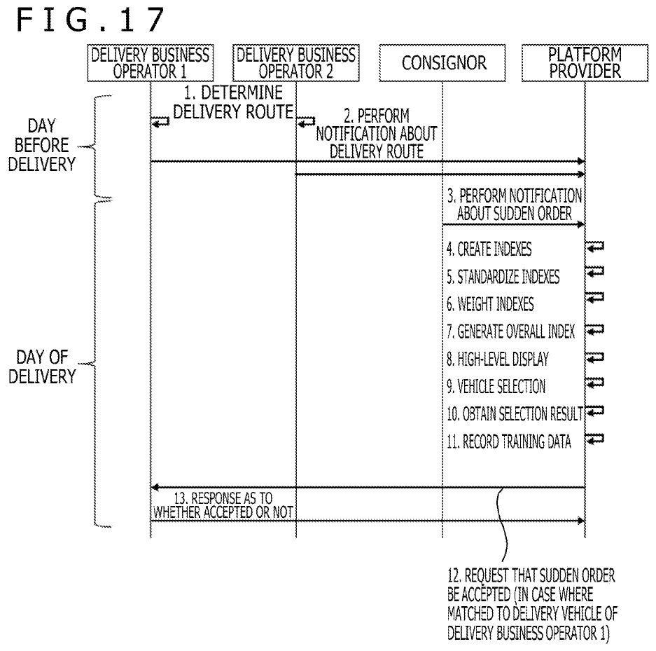

Next, description is given regarding an example of a business flow that uses the vehicle allocation system 11 (in other words, an example of a vehicle sharing service). FIG. 17 is a view for describing an example of a business flow using the vehicle allocation system.

As with the case in the first embodiment, each delivery business operator determines and performs notification about delivery routes in advance and, after a sudden order has arrived, a plurality of indexes are calculated and standardized. However, in the second embodiment, the control unit 2 of the vehicle allocation system 11 can calculate the overall index by using weights recorded in the trained model recording unit 25 by execution of the training processing unit 35.

As with the case in the first embodiment, an operator refers to information displayed on the display apparatus 5 to select and determine a delivery vehicle for which to correct a transportation plan. However, in the second embodiment, the control unit 2 of the vehicle allocation system 11 executes the selection result obtainment unit 34, so that a result of selection made by the operator is obtained and the obtained selection result is recorded in the training data recording unit 24. Note that a subsequent flow (in other words, that a request to accept is notified to a delivery business operator, and that whether or not the delivery business operator will accept the request is notified from the delivery business operator) is the same as the case in the first embodiment.

Accordingly, by virtue of the second embodiment in accordance with the above description, because the overall index is calculated using data obtained from processing for generating a trained model, the vehicle allocation system 11 which can select a delivery vehicle in alignment with past experience is provided.

Note that, in the processing by the training processing unit 35, data (weights caused to act on indexes which are estimated in accordance with adjustment of the trained model) recorded in the training data recording unit 24 may be successively updated.

Next, description is given regarding a vehicle allocation system (1, 11) according to a third embodiment. Note that, across different drawings, a common reference symbol is used for the same part or a part having a similar function to that in the embodiments described above, and duplicate description thereof is omitted.

In the third embodiment, the index calculation processing unit 33 is used to calculate the indexes and the overall index by setting up a plurality of delivery route candidates. In other words, in the third embodiment, by execution of the index calculation processing unit 33 by the control unit 2 of the vehicle allocation system (1, 11), a plurality of indexes are calculated by setting up a plurality of delivery route candidates when allocating a sudden order to one delivery vehicle in the processing for calculating the indexes.

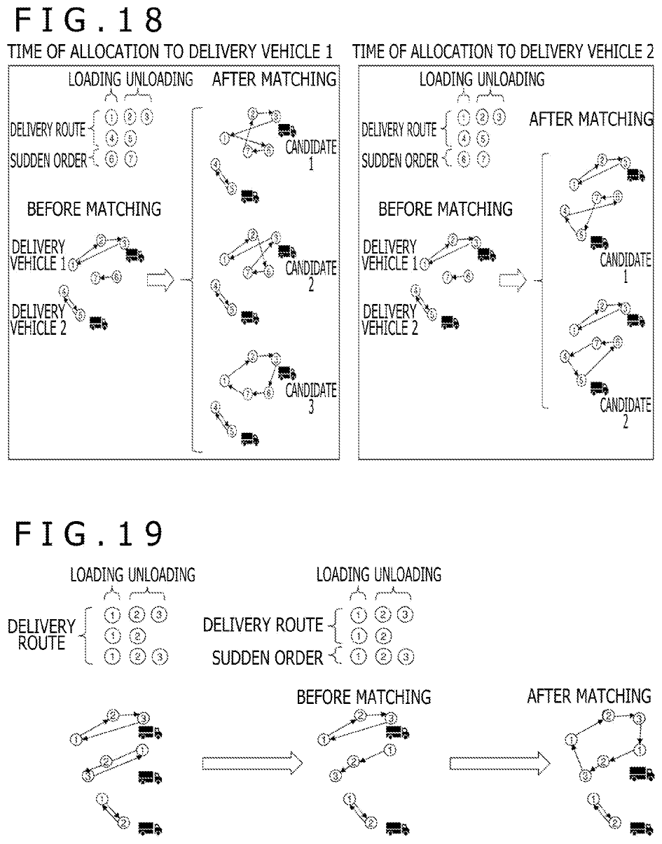

Description is given in detail while referring to FIG. 18. As illustrated in FIG. 18, in a case where a sudden order is allocated to the delivery vehicle 1, a candidate 1 for which the sudden order is allocated between where work location IDs are 1 and 2 (in other words, the sudden order is allocated in place of movement from where the work location ID is 1 to where the work location ID is 2), a candidate 2 for which the sudden order is allocated between where work location IDs are 2 and 3 (in other words, the sudden order is allocated in place of movement from where the work location ID is 2 to where the work location ID is 3), and a candidate 3 for which the sudden order is allocated between where work location IDs are 3 and 1 (in other words, the sudden order is allocated in place of movement from where the work location ID is 3 to where the work location ID is 1) are each set up.

In addition, in a case where a sudden order is allocated to the delivery vehicle 2, a candidate 1 for which the sudden order is allocated between where work location IDs are 4 and 5 (in other words, the sudden order is allocated in place of movement from where the work location ID is 4 to where the work location ID is 5), and a candidate 2 for which the sudden order is allocated between where work location IDs are 5 and 4 (in other words, the sudden order is allocated in place of movement from where the work location ID is 5 to where the work location ID is 4) are each set up.

By execution of the index calculation processing unit 33 by the control unit 2 of the vehicle allocation system (1, 11), indexes for each candidate are calculated. In addition, in the processing for calculating the overall index, the overall index is calculated using a candidate for which a designated index is optimal. In other words, for example, in a case where the “total movement distance” is designated, values of the “total movement distance” for respective candidates are referred to, and the candidate for which the value of the “total movement distance” is a minimum (in FIG. 18, candidate 3 for the delivery vehicle 1 and candidate 2 for the delivery vehicle 2) is employed. The overall index is then calculated using the indexes for the employed candidate.

Note that, regarding which portion of a delivery route to allocate a sudden order and thereby set up a candidate, as in the present embodiment, a candidate may be set up for all cases (in other words, in the case of allocation to the delivery vehicle 1, between where the work location IDs are 1 and 2, between 2 and 3, and between 3 and 1), or it may be that only a candidate for a representative portion is set up. As an example, a representative candidate may be set up, as appropriate, from a delivery route in consideration of a work location on the delivery route and a work location in the sudden order (for example, in consideration of the distance between the work location on the delivery route and the work location in the sudden order).

According to the present embodiment, it is possible to set up a plurality of delivery route candidates and calculate the overall index for an appropriate delivery route from among the plurality of candidates. An operator can then refer to this overall index to select the delivery vehicle for which to correct a transportation plan.

Description has been given above regarding embodiments of the present invention, but the present invention is not limited to the embodiments described above, and various modifications are possible.

In the above description, description has been given regarding allocation of a sudden order based on a sudden order from a consignor, but as illustrated in FIG. 19, for example, in the vehicle allocation system (1, 11), allocation of a sudden order may be performed by a delivery business operator. In this case, information regarding a new delivery package may be obtained by execution of the cargo information recording unit 32, or, in the case where there is information already in the delivery route recording unit 21, this information may be used. Even in the case of handling a sudden order by a delivery business operator, an operator can refer to displayed information in order to select a delivery vehicle which is suitable for the correction of a transportation plan.

In the above description, the “total movement distance,” the “profit distribution,” and the “average ratio of loaded travel distance to total travel distance” are calculated as indexes and an overall index which combines these indexes is calculated, but there may be an index other than the “total movement distance,” the “profit distribution,” and the “average ratio of loaded travel distance to total travel distance.” Even in the case where there is an index other than these, the vehicle allocation system (1, 11) can use weights on the respective indexes to calculate the overall index. For example, “compatibility” or a “vehicle operation time period” may be used as indexes. Note that “compatibility” or a “vehicle operation time period” can be obtained for each delivery vehicle by allocating a sudden order to each delivery vehicle. Information regarding the “compatibility” or the “vehicle operation time period” may be caused to be displayed on the display apparatus 5.

Here, the “compatibility” is an index pertaining to compatibility between a delivery business operator and a consignor, and although a calculation method is not particularly limited if compatibility can be appropriately calculated, compatibility can be calculated on the basis of information regarding transaction experience described above. For example, the “compatibility” can be calculated from a quotient between the number of packages from a consignor for which there is transaction experience, from among packages pertaining to the sudden order, and the total number of packages pertaining to the sudden order (the number of packages for which there is transaction experience and which relate to the sudden order/the total number of packages relating to the sudden order).

For example, assume a case where there are two packages pertaining to a sudden order allocated to a delivery vehicle and there is transaction experience regarding one package (in other words, there is transaction experience in the past between the delivery business operator that sets up the transportation plan for the delivery vehicle to which the sudden order is allocated, and the consignor of the package) and no transaction experience regarding the other package. In this case, because there is one package for which there is transaction experience and one package for which there is no transaction experience, the “compatibility” is calculated as 1/(1+1)=0.5. In this manner, the compatibility between a delivery business operator and a consignor is expressed numerically on the basis of transaction experience. By using the “compatibility” index, it is possible to calculate an overall index for which the compatibility between the vehicle and packages has been considered.

Note that a method for determining whether or not there is transaction experience is not particularly limited if appropriate determination is possible, but, as an example, the determination can be made by using history information regarding whether or not a consignor has in the past used a delivery service provided by the delivery business operator in question (in other words, the delivery business operator to which the allocation of a sudden order is performed). In addition, the determination may be performed by using information (for example, a consignor ID) recorded in the delivery route recording unit 21 or the sudden order recording unit 22. In addition, in a case where information for identifying which delivery business operator a delivery vehicle belongs to is recorded in the delivery route recording unit 21, the determination may be performed by using this information.

The “vehicle operation time period” is an index pertaining to an operation time period of a delivery vehicle, and a calculation method is not particularly limited if the “vehicle operation time period” can be appropriately calculated. For example, it is possible to calculate the “vehicle operation time period” by using a time interval between, for each delivery vehicle, a work start time for a minimum action ID and a work end time for a maximum action ID. By using the “vehicle operation time period” index, it is possible to calculate an overall index for which an operation time period for a delivery vehicle has been considered. Note that the “vehicle operation time period,” as an example, may be represented by a sum total, a variance, or an average of values calculated from each delivery vehicle.

Information for identifying which delivery business operator a delivery vehicle displayed as vehicle allocation candidate information belongs to may be displayed on the display apparatus 5 together with the vehicle allocation candidate information. For example, in the case of recording information for identifying which delivery business operator a delivery vehicle belongs to in the delivery route recording unit 21, using this information, information for identifying which delivery business operator a delivery vehicle displayed as vehicle allocation candidate information belongs to may be displayed on the display apparatus 5 together with the vehicle allocation candidate information.

A CPU can be considered as an example of a processor, but a processor may be another semiconductor device (for example, a graphics processing unit (GPU)) if this semiconductor device is an agent that executes predetermined processing.

The recording unit 3 may be configured from a singular recording apparatus, or the recording unit 3 may be configured from a plurality of recording apparatuses. In addition, regarding data recording, it is sufficient if appropriate recording is executed and, as a result, processing can be appropriately executed by the vehicle allocation system (1, 11). For example, data may be recorded in a plurality of recording apparatuses in a divided manner.

The number of delivery vehicles handled by the vehicle allocation system (1, 11) may be larger than the number of delivery vehicles described above. There may also be a plurality of consignors who transmit sudden orders or a plurality of delivery business operators.

In the case where there is a plurality of sudden orders, the plurality of sudden orders may be processed in combination, or the sudden orders may be distinguished from each other to be processed. In the case where sudden orders are processed in combination, for example, the same delivery vehicle ID may be assigned to each sudden order in the sudden order recording unit 22. In the case where sudden orders are distinguished from each other to be processed, different delivery vehicle IDs may be assigned for sudden orders desired to be distinguished.

A method of transmitting information to the vehicle allocation system (1, 11) or the platform provider is not particularly limited. For example, a delivery business operator may collectively transmit delivery routes for their own delivery vehicles, or a driver scheduled to use a delivery vehicle on the day may individually transmit a delivery route.

What is claimed is:

1. A vehicle allocation system operable to evaluate, in relation to a plurality of delivery vehicles having transportation plans determined in advance, which transportation plan for a delivery vehicle is to be corrected when adding delivery of a new package and display an evaluation result, the system comprising:
a processor; a recording unit; and a display apparatus,
wherein a vehicle information recording unit configured to record information regarding a delivery vehicle, a cargo information recording unit configured to record information regarding a new delivery package, and an index calculation processing unit configured to calculate a plurality of indexes and execute display of information based on the calculated indexes are disposed as programs in the recording unit, and
the processor
reads the vehicle information recording unit to record information regarding a delivery vehicle in the recording unit,
reads the cargo information recording unit to record information regarding a new delivery package in the recording unit,
reads the index calculation processing unit to, on a basis of information obtained by executing the vehicle information recording unit and the cargo information recording unit, calculate for each delivery vehicle an index pertaining to movement distance, an index pertaining to profit, and an index pertaining to a ratio of loaded travel distance to total travel distance,
uses weights on the calculated indexes to calculate for each delivery vehicle an overall index which is an overall index which is an overall index that combines the indexes, and
causes the display apparatus to display information regarding the index pertaining to movement distance, information regarding the index pertaining to profit, information regarding the index pertaining to the ratio of loaded travel distance to total travel distance, and vehicle allocation candidate information which is information in which the overall indexes for the respective delivery vehicles are lined up in descending order.

2. The vehicle allocation system according to claim 1, further comprising:
a selection result obtainment unit; a training data recording unit; a training processing unit; and a trained model recording unit,
wherein the selection result obtainment unit is a program used to obtain and record information regarding a plurality of indexes and a delivery vehicle for which the transportation plan has been corrected,
information obtained by execution of the selection result obtainment unit is recorded as training data in the training data recording unit,
the training processing unit is a program used to, using the training data recorded in the training data recording unit, generate a trained model for, in response to input of a plurality of indexes, causing output of a delivery vehicle for which correction of the transportation plan is probable and, using the generated trained model, calculate and record a weight of each index,
the weights of the respective indexes calculated by execution of the training processing unit are recorded in the trained model recording unit, and
the processor
reads the selection result obtainment unit to obtain information regarding a plurality of indexes and the delivery vehicle for which the transportation plan has been corrected and record the obtained information in the training data recording unit,
reads the training processing unit to, using the training data recorded in the training data recording unit, generate a trained model for, in response to input of a plurality of indexes, causing output of a delivery vehicle for which correction of the transportation plan is probable and, using the generated trained model, calculate a weight of each index and record the calculated weights in the trained model recording unit, and,
in processing for calculating the overall index using the index calculation processing unit, calculates the overall index using the weights recorded in the trained model recording unit.

3. The vehicle allocation system according to claim 1, wherein
the processor reads the index calculation processing unit to, in processing for calculating a plurality of indexes for each delivery vehicle, set up a plurality of delivery route candidates for each delivery vehicle, calculate indexes for each delivery route candidate, and employ an optimal candidate from among the delivery route candidates.

4. The vehicle allocation system according to claim 1, wherein
the processor reads the index calculation processing unit to calculate for each delivery vehicle an index pertaining to compatibility between a delivery business operator and a consignor, and use the index to calculate the overall index.

5. The vehicle allocation system according to claim 1, wherein
the processor reads the index calculation processing unit to calculate for each delivery vehicle an index pertaining to a delivery vehicle operation time period, and use the index to calculate the overall index.

6. A vehicle candidate display method for evaluating, in relation to a plurality of delivery vehicles having transportation plans determined in advance, which transportation plan for a delivery vehicle is to be corrected when adding delivery of a new package, and displaying an evaluation result,
the method using a processor, a recording unit, and a display apparatus,
the recording unit having, disposed therein as programs, a vehicle information recording unit configured to record information regarding a delivery vehicle, a cargo information recording unit configured to record information regarding a new delivery package, and an index calculation processing unit configured to calculate a plurality of indexes and execute display of information based on the calculated indexes,
the method comprising:
a delivery vehicle information recording step of the processor reading the vehicle information recording unit to record information regarding a delivery vehicle in the recording unit;
a cargo information recording step of the processor reading the cargo information recording unit to record information regarding a new delivery package in the recording unit;
an index calculation step of the processor reading the index calculation processing unit to, on a basis of information obtained by executing the vehicle information recording unit and the cargo information recording unit, calculate for each delivery vehicle an index pertaining to movement distance, an index pertaining to profit, and an index pertaining to a ratio of loaded travel distance to total travel distance;
an overall index calculation step of the processor reading the index calculation processing unit and using weights on the calculated indexes to calculate for each delivery vehicle an overall index which is an overall index that combines the indexes; and
a vehicle allocation candidate display step of the processor reading the index calculation processing unit to cause the display apparatus to display information regarding the index pertaining to movement distance, information regarding the index pertaining to profit, information regarding the index pertaining to the ratio of loaded travel distance to total travel distance, and vehicle allocation candidate information which is information in which the overall indexes for the respective delivery vehicles are lined up in descending order.

7. The vehicle candidate display method according to claim 6, wherein
a selection result obtainment unit, a training data recording unit, a training processing unit, and a trained model recording unit are used,
the selection result obtainment unit is a program used to obtain and record information regarding a plurality of indexes and a delivery vehicle for which the transportation plan has been corrected,
information obtained by execution of the selection result obtainment unit is recorded as training data in the training data recording unit,
the training processing unit is a program used to, using the training data recorded in the training data recording unit, generate a trained model for, in response to input of a plurality of indexes, causing output of a delivery vehicle for which correction of the transportation plan is probable and, using the generated trained model, calculate and record a weight of each index,
the weights of the respective indexes calculated by execution of the training processing unit are recorded in the trained model recording unit,
the method further includes
a training data recording step of the processor reading the selection result obtainment unit to obtain information regarding a plurality of indexes and the delivery vehicle for which the transportation plan has been corrected and record the obtained information in the training data recording unit, and
a training processing step of the processor reading the training processing unit to, using the training data recorded in the training data recording unit, generate a trained model for, in response to input of a plurality of indexes, causing output of a delivery vehicle for which correction of the transportation plan is probable and, using the generated trained model, calculate a weight of each index and record the calculated weights in the trained model recording unit, and
in the overall index calculation step using the index calculation processing unit, the processor uses the weights recorded in the trained model recording unit to calculate the overall index.

8. The vehicle candidate display method according to claim 6, wherein
the processor, in the index calculation step, sets up a plurality of delivery route candidates for each delivery vehicle, calculates indexes for each delivery route candidate, and employs an optimal candidate from among the delivery route candidates.

9. The vehicle candidate display method according to claim 6, wherein
the processor, in the index calculation step, calculates for each delivery vehicle an index pertaining to compatibility between a delivery business operator and a consignor, and
the processor, in the overall index calculation step, uses the index to calculate the overall index.

10. The vehicle candidate display method according to claim 6, wherein
the processor, in the index calculation step, calculates for each delivery vehicle an index pertaining to a delivery vehicle operation time period, and
the processor, in the overall index calculation step, uses the index to calculate the overall index.
